(19) United States
(12) Patent Application Publication
(10) Pub. No.: US 2012/0031135 A1
(43) Pub. Date: Feb. 9, 2012

(54) Apparatus for Producing Flake Ice and Method for Cleaning, Descaling and/or Disinfecting an Apparatus for Producing Flake Ice

(75) Inventor: Joachim Schill, Kehl (DE)

(73) Assignee: MAJA-MASCHINENFABRILK HERMANN SCHILL GmbH &Co. KG, Kehi-Golgscheuer (DE)

(21) Appl. No.: 13/262,750

(22) PCT Filed: Apr. 1, 2010
(86) PCT No.: PCT/DE2010/000383

§ 371 Date: Oct. 3, 2011

(30) Foreign Application Priority Data
Apr. 9, 2009 (DE) 102009016726.9

(51) Int. Cl. F25D 23/00; F25C 5/02; B08B 1/00; F25C 1/10

(52) U.S. Cl. 62/303; 134/6

(57) ABSTRACT

An apparatus for producing flake ice from a liquid is, and a process for cleaning an apparatus for producing flake ice are disclosed. The apparatus is equipped with a rotatably disposed evaporator roller, a shaft on the evaporator roller, the shaft transmitting a torque from a drive unit to the evaporator roller, with a scraper to remove ice formed from the liquid on the surface of the evaporator roller, with a pan to receive the liquid, in which pan the evaporator roller is at least partially immersed, and with a cleaning device to effect cleaning, descaling, and/or disinfection. The cleaning device includes at least one supply inlet for a cleaning liquid discharging into the pan, and one circulation device that circulates the cleaning liquid in the pan and creates a flow on the part of the cleaning liquid in the pan.

### FIELD OF THE INVENTION

The invention is based on an apparatus for producing flake ice, and a process for cleaning an apparatus for producing flake ice.

### BACKGROUND OF THE INVENTION

Apparatuses for producing flake ice function to produce ice in the form of thin flakes from liquids, in particular, water. The ice is identified as flake ice due to the shape of the ice pieces. The flake ice is utilized, for example, in the food industry to produce food and to keep food fresh during transport and storage. As a result, for example, meat, fish, or seafood can be stored and transported such that their quality does not suffer. In addition, flake ice is used in the production of sausage. Other liquids besides water can be processed into flake ice, such as, for example, juices, sauces, egg, milk, and milk products. In addition to these, flake ice produced from a variety of liquids is used in medicine, pharmacy, and engineering.

Especially stringent hygienic requirements must be met by the apparatuses in all areas of application when producing flake ice. To this end, any soiling, contamination, lime scale, and pathogenic organisms, in particular, bacteria, viruses, molds, and protozoa, must be removed from all surfaces coming in contact with the flake ice. The apparatus must be thoroughly cleaned at regular intervals, and descaled and disinfected as necessary. It is particularly important in this regard to clean the pan in which a pool of liquid is found when the apparatus is operating, and in some cases also during idle times between startups. Germs can propagate unhindered in this pool of liquid. Regularly emptying the pan is not a sufficient action for reliably removing pathogens and molds from the surfaces.

DE 410 8911 A1 discloses a flake ice machine comprising a pan and an evaporator roller that is rotatably disposed on the pan, the machine being equipped with a switchable cleaning device for rinsing the pan and the evaporator roller. To this end, the cleaning device includes multiple spray nozzles to spray the evaporator roller and the pan with a cleaning agent. This approach has been found disadvantageous in that the pan must be equipped with special spray nozzles at the time the flake ice machine is manufactured, with the result that it is not possible to retrofit existing machines. In addition, spray nozzles must be disposed in terms of their number and the orientation of the spray cone so as to ensure that a reliable cleaning is effected of the pan, evaporator roller, and other parts contacting the freezing liquid. This results in a high cost to produce the flake ice machine.

The object of this invention is to provide an apparatus for producing flake ice and a process for cleaning an apparatus for producing flake ice whereby a reliable cleaning, descaling, and/or disinfection of all parts contacting the liquid to be frozen is ensured, along with a simple design in terms of construction and equipment. In addition, it should also be possible to retrofit existing apparatuses.

### SUMMARY OF THE INVENTION

The apparatus according to the invention for producing flake ice comprising the features of claim 1, and the process according to the invention comprising the features of claim 12 is distinguished by the fact that a cleaning device is provided to effect cleaning, descaling, and/or disinfection, the device being equipped with an additional circulation device. The circulation device includes a drive unit. This preferably involves a drive unit that is separate from and independent of the drive unit of the evaporator roller. The circulation device generates a flow in a cleaning liquid within the pan that enhances the removal and flushing out of contamination, lime scale, and pathogens from the apparatus. This involves a flow that can be variable as a function of the power of the drive unit. This is stronger than the flow generated by the evaporator roller. The pan here is preferably filled up to a specified level. This level can either match a specified level for filling the pan with the liquid to be frozen, or can deviate from this. The pan is preferably filled almost completely, thereby enabling those parts to come into contact with the cleaning liquid that also come into contact with the liquid to be frozen when the apparatus is operating. The circulation device serves to set the cleaning liquid in pan in motion. Due to the pan's being filled up to a specified maximum level and due to the circulation of the cleaning liquid, an intensive and permanent contact is created during the cleaning process between the cleaning liquid and the relevant parts of the apparatus. In particular, these include the pan and the evaporator roller. The evaporator roller preferably rotates during the cleaning process. The flow of cleaning liquid is supported by this motion of the evaporator roller. This achieves a uniform cleaning, descaling, and/or disinfection of the evaporator roller. The surfaces contacting the cleaning liquid cannot dry out due to the cleaning liquid bath held in the pan. Thanks to the flow of cleaning liquid maintained by the circulation device, a homogeneous distribution of the cleaning liquid in the pan is achieved. In addition, a sufficient quantity of cleaning liquid is always provided at all sites of the apparatus to be cleaned throughout the entire cleaning process. The flow furthermore supports the removal of contamination, bacteria, and lime scale due to the mechanical interaction between the cleaning liquid and the relevant surfaces of the apparatus.

Water, or a mixture of water and cleaning agent, can be employed as the cleaning liquid. Examples of cleaning agents that are appropriate here include agents that contain citric acid, acetic acid, or chlorine compounds. The cleaning liquid and cleaning agent determine whether what is effected is a cleaning of the apparatus including descaling and disinfection—or only a cleaning, only a descaling, or only a disinfection.

The cleaning liquid is introduced into the pan. This is implemented by a supply inlet that discharges into the pan. This can either be a supply inlet for the liquid to be frozen, or an additional supply inlet that functions only to feed in the cleaning liquid. The supply inlet can discharge into the pan either from the top or from the side. Unlike the cleaning nozzles known in the prior art, one supply inlet is sufficient here which does not have to satisfy any special requirements in terms of the direction of the exiting cleaning liquid or in terms of the opening angle.

After the cleaning process is complete, the cleaning liquid is drained from the pan. The pan is subsequently filled one or more times with fresh water, and the fresh water then emptied. This ensures that no residual cleaning liquid, or any contamination particles, scale particles, or bacteria, remain in the pan that could then enter the ice when flake ice is subsequently produced. Before emptying, the circulation device can be operated so as to cause the fresh water to flow. This additionally enhances the flushing out of cleaning liquid, as well as any soiling, contamination, lime scale, and pathogens.

The circulation device is disconnected from the supply inlet for the liquid to be frozen. The cleaning liquid flowing in the pan is separated completely from the supply inlet of liquid to be frozen through which the pan is filled with the liquid to be frozen when operating. This prevents the cleaning liquid from flowing into the supply inlet for the liquid to be frozen and causing contamination of the liquid to be frozen. No additional system isolation is required between the circuit for the cleaning liquid and the supply inlet of the liquid to be frozen.

No strict requirements must be met in terms of the pressure built up by the circulation device for purposes of circulating the cleaning liquid, and optionally for the flushing process with fresh water after this circulation. The circulation device, and optionally a metering device for the cleaning agent, can therefore be composed of inexpensive components.

This cleaning device can either be installed during the manufacture of the apparatus for producing flake ice or can be retrofitted on existing apparatuses.

In an advantageous embodiment of the invention, the circulation device includes a circulation pump that draws the cleaning liquid from the pan and returns it to the pan. To this end, a shape-stable or flexible tube can be provided in another advantageous embodiment of the invention, the tube connecting the circulation pump at the suction end and/or at the delivery end with the pan. This can be a detachably fixed connection. Circulation pump, tube, and pan together constitute a circuit for the cleaning liquid. The cleaning liquid circulates in this circuit during the cleaning process. The circulation pump can also be actuated during the flushing process in which the cleaning liquid is flushed from the pan after the cleaning process is completed. Actuating the circulation pump during the flushing process with fresh water also ensures that cleaning liquid is also purged from the tube connecting the pan to the circulation pump.

In another advantageous embodiment of the invention, the tube through which the cleaning liquid is returned by the circulation pump to the pan discharges into the pan from the top. This has the advantage that no design modifications have to be implemented on the pan to enable installation of the cleaning device.

In another advantageous embodiment of the invention, the tube discharges below a level specified for filling the pan. This prevents any undesirable excessive foaming from being created during the circulation of the cleaning liquid that is effected by the circulation pump.

In another advantageous embodiment of the invention, the circulation device includes an immersion pump disposed in the pan. The pump returns the cleaning liquid directly from the pan back into the pan without having to depend on a supplementary tube outside the pan. If the immersion pump is not permanently connected to the pan, it can be removed from the pan when the flake ice is produced.

In another advantageous embodiment of the invention, the circulation device has an stirring mechanism. This enables the cleaning liquid to flow within the pan. The stirring mechanism can be composed of a driven shaft comprising one or more axially or radially conveying stirrers. Instead of the supplementary driven shaft, the stirrers can also be attached to the evaporator roller. This can be either a releasable or a permanent attachment between the stirrers and the evaporator roller. Stirrers that are permanently attached to the evaporator roller are preferably disposed at the end faces of the evaporator roller. The stirrers are moved in the cleaning liquid contained in the pan by means of the rotation of the supplementary shaft or the rotation of the evaporator roller, thereby ensuring the flow and circulation.

In another advantageous embodiment of the invention, the apparatus is equipped with a cleaning agent supply inlet that discharges into the pan and/or into the tube. A special cleaning agent is added through the supply inlet to the cleaning liquid in the pan or in the tube that connects the pan to the circulation pump. This provides the advantage that water, for example, can be fed through the supply inlet to the liquid to be frozen in the pan, while the addition of a cleaning agent is only effected subsequently through a separate cleaning agent supply inlet. The cleaning agent thus does not come into contact with the supply inlet of the liquid to be frozen.

In another advantageous embodiment of the invention, the cleaning agent supply inlet is connected to a reservoir for the cleaning agent. A supply of cleaning agent is available for each cleaning operation.

In another advantageous embodiment of the invention, the apparatus is equipped with a cleaning agent metering pump. This pump can feed in the quantify of cleaning agent required for a cleaning operation. Since the pump does not have to work against the pressure of the cleaning agent, no strict requirements have to be satisfied in terms of building up a pressure by the cleaning agent metering pump.

In another advantageous embodiment of the invention, the cleaning agent supply inlet discharges above a level specified for filling the pan. This prevents liquid filling the pan from coming into contact with the cleaning agent supply inlet, and unwanted flushing out of cleaning agent from the cleaning agent supply inlet.

In another advantageous embodiment of the invention, the apparatus is equipped with a control device. In this case, the circulation device—for example, the circulation pump, immersion pump, or stirring mechanism—is connected to the control device. If the apparatus is additionally equipped with a cleaning agent metering pump, this pump is also connected to the control device. If this rotation of the evaporator roller is also integrated in the cleaning operation, it is then also connected to the control device. The control device controls the components of the cleaning device and ensures that the cleaning operation runs according to specification.

In another advantageous embodiment of the invention, the apparatus is equipped with a level sensor to monitor the level specified to fill the pan. The level sensor determines when the filling of the pan has reached or exceeded a specified level. This enables measures to be initiated that prevent the level from rising further.

In another advantageous embodiment of the invention, the supply inlet for the cleaning liquid is identical to a supply inlet for the liquid to be frozen.

In another advantageous embodiment of the invention, the lower region of the pan is equipped with a drain to drain the cleaning liquid from the pan. The drain can be identical to a drain for the liquid to be frozen, in particular, for residual amounts of the liquid to be frozen that are located in the pan.

The process according to the invention for cleaning an apparatus for producing flake ice comprising the features of claim 12 is distinguished by the fact that, after all of the liquid to be frozen located in the pan has been drained, the pan is filled up to a specified level with cleaning liquid, and the cleaning liquid is circulated and caused to flow. An additional circulation device serves this purpose. The evaporator roller can be equipped with stirrers or stirring elements to support the generation of a flow in the cleaning liquid. Depending on the type of flow, a circulation also takes place. The cleaning liquid is drained from the pan after the flow has ended. A drain in the bottom region of the pan preferably functions to drain the liquids from the pan. This drain is preferably located at the lowest point of the pan so as to ensure no residual quantities remain in the pan after draining.

The process is implemented as long as no flake ice is produced in the apparatus. To this end, the process is either implemented when the apparatus is idle in any case, or the production of ice is terminated when the process is initiated.

In an advantageous embodiment of the invention, the apparatus is flushed once or multiple times with water after the cleaning liquid has been drained so as to purge the cleaning liquid, and any possible residual contamination, lime scale, or pathogens from the apparatus.

In an advantageous embodiment of the invention, the operating and/or idle times for when the apparatus is producing flake ice are recorded. The operating and idle times can be used along with the predetermined water hardness to determine a time when a cleaning of the apparatus is to be effected. The hygienic state of the apparatus determined therefrom can be displayed to the user by a display device. Once a critical hygienic state has been reached, the process for cleaning can be started automatically, or a corresponding recommendation to manually start the process can be issued to the user.

The cleaning process can be either started manually by a user, or automatically by a timer unit integrated in the apparatus before production of flake ice begins or after it has ended.

Additional advantages and advantageous embodiments of the invention are revealed in the following discussion, drawing, and claims.

### BRIEF DESCRIPTION OF THE INVENTION

The drawing illustrates one exemplary embodiment of the invention. In the drawing:

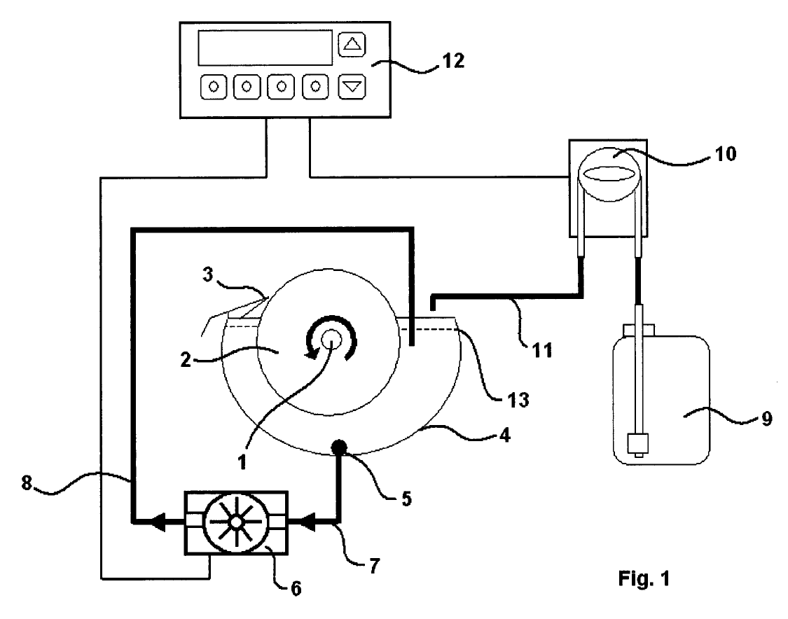

FIG. 1 is a schematic diagram of showing the constructive design of the apparatus for producing flake ice;

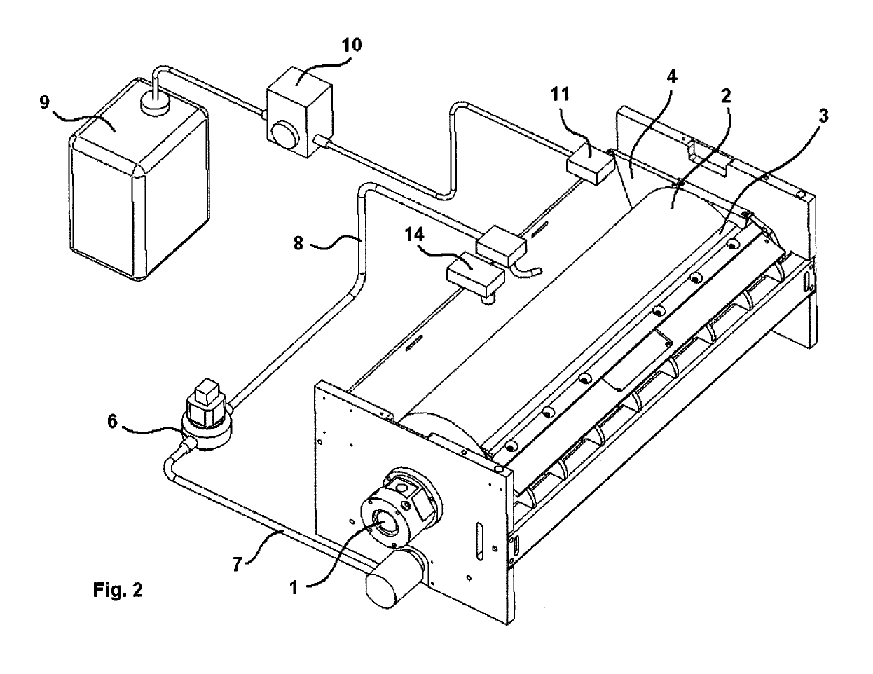

FIG. 2 is a perspective view of the apparatus of FIG. 1;

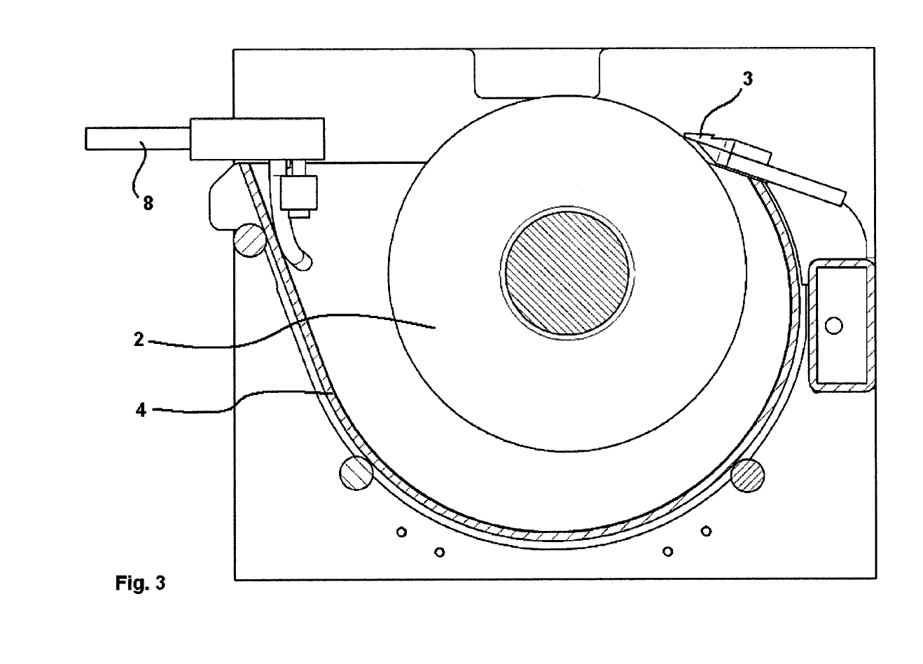

FIG. 3 is a side view of the apparatus of FIG. 1;

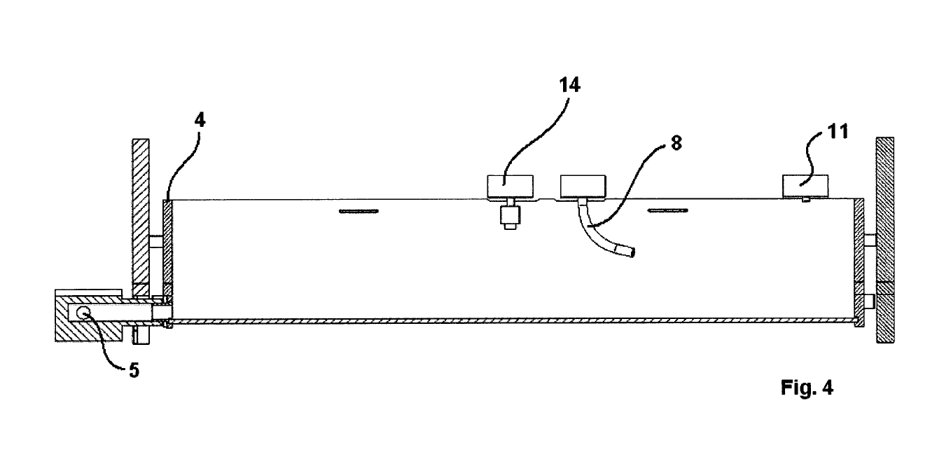

FIG. 4 provides a rear view of the apparatus of FIG. 1.

### DESCRIPTION OF THE EMBODIMENT

FIG. 1 is a schematic view illustrating the constructive design of an apparatus for producing flake ice, the apparatus being equipped with a cleaning device to effect cleaning, descaling, and/or disinfection. In order to produce ice, the apparatus includes an evaporator roller 2 driven by a shaft 1 to effect rotation, a scraper 3 to remove ice created from the liquid to be frozen at the surface of evaporator roller 2, and a pan 4 to receive the liquid to be frozen. Evaporator roller 2 is at least partially immersed in this pan 4. The rotation of evaporator roller 2 in FIG. 1 is indicated by an arrow. The supply inlet for the liquid to be frozen is not shown in the drawing. A drain 5 in pan 4 functions to drain liquid contained in the pan. The apparatus is equipped with a cleaning device to effect cleaning, descaling, and disinfection. Included in the cleaning device are a circulation pump 6, a tube 7 that connects circulation pump 6 at the suction end with drain 5 of pan 4, a tube 8 that is connected to circulation pump 6 at the delivery end, a reservoir 9 for cleaning agent, a cleaning agent metering pump 10, a cleaning agent supply inlet 11, and a control device 12.

The cleaning of the apparatus for producing flake ice proceeds as follows: production of ice is terminated if this has not already happened. Although evaporator roller 2 is no longer cooled, it nevertheless continues to rotate about its axis until no more ice is formed along the surface of the evaporator roller. Pan 4 is then emptied completely through drain 5. All of the liquid to be frozen is drained that is contained in the pan. Pan 4 is then filled up to a specified level 13 with a cleaning liquid, for example, water. The fill level is monitored by a level sensor 14, which is illustrated in FIGS. 2 and 4. After pan 4 is filled up to level 13, circulation pump 6 is switched on. A cleaning agent is added by a cleaning agent metering pump 10 and through cleaning agent supply inlet 11 to the cleaning liquid in pan 4. Cleaning agent supply inlet 11 discharges from the top into pan 4. The orifice is situated above level 13 of the cleaning liquid. The cleaning liquid containing the cleaning agent is drawn by circulation pump 6 through drain 5 and tube 7 and returned from the top through tube 8 into pan 4. The orifice of tube 8 is located below level 13. This prevents any unwanted foaming from occurring when the cleaning liquid is introduced into the pan. Evaporator roller 2 rotates as the cleaning liquid circulates. The circulation of the cleaning liquid is terminated by switching off the circulation pump. After the pump is switched off, the cleaning liquid is drained from pan 4 through drain 5, thus emptying pan 4. The pan is then flushed multiple times with fresh water. The pan is filled through a supply inlet, not shown, with fresh water for this purpose. Circulation pump 6 is then switched on to enable circulation pump 6 and tubes 5 and 6 to be flushed with fresh water. The evaporator roller rotates during the flushing process. After the flushing process is completed, the cleaned and disinfected apparatus is once again available to produce flake ice.

FIGS. 2, 3, and 4 provide different views of the apparatus for producing flake ice. To enhance clarity, not all components of the apparatus are included in FIGS. 2 through 4.

All of the features of the invention can be essential to the invention, both individually and in any combination with each other.

1.-15. (canceled)

16. Apparatus for producing flake ice from a liquid, comprising:
a rotatably disposed evaporator roller;
a shaft on the evaporator roller to transmit a torque from a drive unit to the evaporator roller;
a scraper to remove ice formed from the liquid on the surface of the evaporator roller;
a pan to receive the liquid, in which pan the evaporator roller is at least partially immersed;
a cleaning device to effect cleaning, descaling, and/or disinfection;
at least one supply inlet discharging into the pan for a cleaning liquid of the cleaning device; and
a circulation device of the cleaning device, the circulation device being provided in addition to the evaporator roller and equipped with a drive unit, which circulation device circulates the cleaning liquid in the pan and creates a flow on the part of the cleaning liquid in the pan.

17. Apparatus according to claim 16, wherein the circulation device includes a circulation pump that draws the cleaning liquid from the pan and returns it to the pan.

18. Apparatus according to claim 17, wherein the circulation pump is connected to the pan by a shape-stable or flexible tube at the suction end and/or at the delivery end.

19. Apparatus according to claim 18, wherein the tube through which the cleaning liquid is returned by the circulation pump to the pan discharges into the pan from the top.

20. Apparatus according to claim 19, wherein the tube discharges below a level specified for filling the pan.

21. Apparatus according to claim 16, wherein the circulation device includes an immersion pump disposed in the pan.

22. Apparatus according to claim 16, wherein the circulation device includes a stirring mechanism.

23. Apparatus according to claim 16, wherein the apparatus is equipped with a cleaning agent supply inlet that discharges into the pan.

24. Apparatus according to claim 23, wherein the cleaning agent supply inlet discharges above a level specified for filling the pan.

25. Apparatus according to claim 16, wherein the apparatus is equipped with a level sensor to monitor the level specified for filling the pan.

26. Apparatus according to claim 16, wherein the supply inlet for the cleaning liquid is identical to a supply inlet for the liquid to be frozen.

27. Process for effecting the cleaning, descaling, and/or disinfection of an apparatus for producing flake ice, the apparatus comprising a rotatably disposed evaporator roller, a scraper to remove ice formed from the liquid on the surface of the evaporator roller, a pan to receive the liquid, in which pan the evaporator roller is at least partially immersed, the process comprising the following steps:
draining any liquid to be frozen still located in the pan;
filling the pan with a cleaning liquid up to a specified level;
circulating the cleaning liquid of the pan so as to create a flow; and
draining the cleaning liquid from the pan.

28. Process according to claim 27, wherein a cleaning agent is added to the cleaning liquid.

29. Process according to claim 27 wherein during the circulation of the cleaning liquid the cleaning liquid is drawn out of the pan and then introduced below the specified level into the pan.

30. Process according to claim 27 wherein the operating and/or idle times of the apparatus for producing flake ice are recorded.
